(19) United States
(12) Patent Application Publication
(10) Pub. No.: US 2008/0062553 A1
(43) Pub. Date: Mar. 13, 2008

(54) Disk recording medium and information recording apparatus

(75) Inventor: Takayuki Kawabe, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED

(21) Appl. No.: 11/652,953

(22) Filed: Jan. 12, 2007

(30) Foreign Application Priority Data
Sep. 8, 2006 (JP) 2006-244348

(51) Int. Cl. G11B 5/09; G11B 5/596

(52) U.S. Cl. 360/48; 360/77.08

(57) ABSTRACT

In the case of a magnetic head tracing a record track from the left to right, a positional demodulation signal obtained by passing a first servo sector existing in the record track is minutely corrected by a positional correction signal converted from a phase shift amount which is obtained by sequentially passing at least plurally placed correction areas, thereby becoming a positional signal, followed by obtaining a positional modulation signal in the same manner at a second servo sector existing in the record track subsequently traced, and further minutely corrected by a positional correction signal obtained by passing similar plural correction areas arrayed at discretionary intervals starting from the second servo area. Such minute correction operations are performed for one circumference of a track, which is continued for carrying out an accurate positioning trace to a target track.

### BACKGROUND OF THE INVENTION

1. Field of the Invention

The present invention relates to a disk recording medium and information recording apparatus used for recording and reproducing information.

2. Description of the Related Art

In recent years, magnetic disk apparatuses have been in the very midst of reducing in their sizes, and accordingly demanded is a development of a disk medium capable of a high density recording. A problem associated with an increased recording density of a magnetic disk apparatus, however, is a way to prevent interference from an adjacent record bit.

In recognition of such a problem, a conventionally proposed is a technique called as discrete track recording which divides a magnetic disk medium physically to individual recording tracks and reduces interference from an adjacent track as a countermeasure to interference in the radial direction of the magnetic disk medium.

Furthermore, based on a recognition of the problem as described above, another conventionally proposed technique is called as “patterned media” which divides a disk medium physically in the circumferential direction of a magnetic disk medium, that is, performs a patterning in the unit of record bit, thereby reducing interference from an adjacent bit (refer to a patent document 1).

Related to the “patterned media”, another conventionally proposed technique is to further reduce interference from an adjacent bit by arraying a land part between adjacent tracks alternately (refer to a patent document 2).

It is a very difficult task of having to solve both problems, i.e., the problem of preventing interference from an adjacent record bit and that of performing an accurate position of the magnetic head to a high density recording medium.

Under such circumstances, a conventionally proposed is a magnetic recording apparatus employing a sector servo system which controls a positioning of a magnetic head to a predetermined position on a record film by using, as cue, servo information recorded in a servo sector zone which is equipped in a predetermined area on the record film in the same manner as a magnetic disk medium having a continuous record film even on a magnetic disk medium having a physically divided record film such as the above noted patterned medium (refer to a patent document 3).

[Patent document 1] Laid-Open Japanese Patent Application Publication No. H09-297918

[Patent document 2] Laid-Open Japanese Patent Application Publication No. 2002-109712

[Patent document 3] Laid-Open Japanese Patent Application Publication No. 2006-31848 (refer to FIG. 3)

### SUMMARY OF THE INVENTION

The above described positioning control for a magnetic head employing the sector servo system is a technique for positioning the magnetic head by using, as cue, a servo pattern recorded in a servo sector zone, requiring a configuration capable of detecting an positioning error in high accuracy and related to a data track per se in order to control an accurate positioning of the magnetic head especially on a physically divided record film.

However, neither the patent document 1 nor 2 as quoted above has disclosed any specifics on a positioning error detection method in high accuracy and related to a data track per se.

A purpose of the present invention is to add means capable of detecting a positioning error related to a data track per se for a disk recording medium. Another purpose is to have a capability of detecting a positioning error in high accuracy and related to a data track per se.

In order to achieve the purposes as described above, a disk record medium according to the present invention is one having a track for recording data and comprising a servo sector in which a servo sector recording address information for positioning a head is intermittently placed in the track direction comprises at least one correction area usable for correcting a position of the head, in between the servo sectors in the track direction. Such comprised disk record medium makes it possible to carry out a positioning control of a head in high accuracy.

Meanwhile, an information recording apparatus according to the present invention is one which reproduces information of a disk record medium enabling a reproduction of the information, or a recording of it therein, by a head moving in a direction of a track on the disk record medium, wherein the disk record medium comprises a servo sector and at least one correction area between servo sectors in the track direction so as to divide and manage a record zone by the track and sector, to record address information for positioning the head and to divide a track, wherein the correction area is utilized for correcting a position of the head. Such comprised information recording apparatus is capable of detecting a positioning error in high accuracy and related to a data track per se and carrying out a positioning control of the head in high accuracy based on the detected positioning error.

### BRIEF DESCRIPTION OF THE DRAWINGS

FIG. 1 is a diagram showing an information recording apparatus according to a preferred embodiment of the present invention;

FIG. 2 is a diagram of a circuit block for performing a positioning control of a head of an information recording apparatus according to a preferred embodiment of the present invention;

FIG. 3 is a diagram showing a signal waveform in the circuit block shown in FIG. 2;

FIG. 4 is a diagram showing the first fundamental comprisal of a magnetic pattern in an information recording apparatus according to a preferred embodiment of the present invention;

FIG. 5 is a diagram showing a reproduction signal waveform when tracing by offsetting a magnetic head from the center of a record track in the first fundamental comprisal of a magnetic pattern shown in FIG. 4; and

FIG. 6 is a diagram showing the second fundamental comprisal of a magnetic pattern in an information recording apparatus according to a preferred embodiment of the present invention.

### DESCRIPTION OF THE PREFERRED EMBODIMENTS

The following is a description of the preferred embodiment of the present invention by referring to the accompanying drawings.

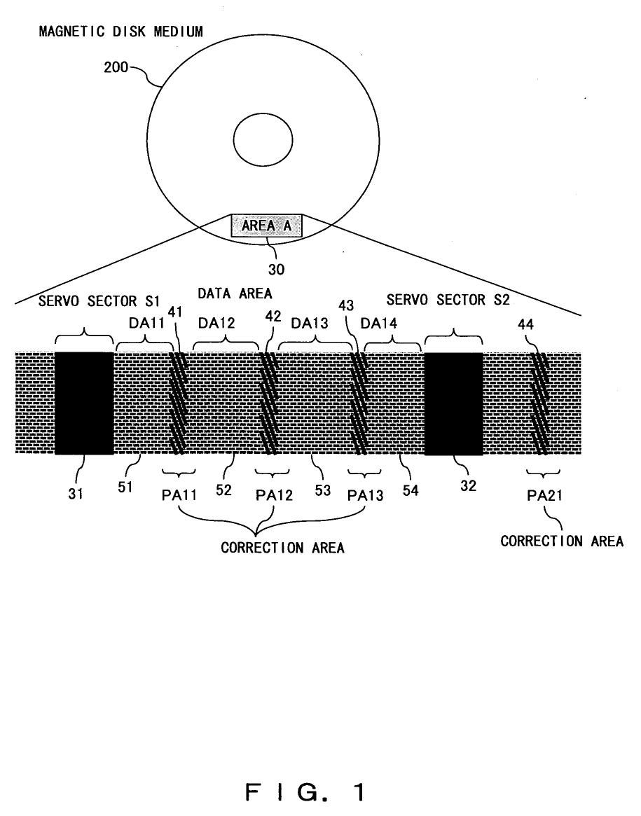

FIG. 1 is a diagram showing an information recording apparatus according to a preferred embodiment of the present invention. The information recording apparatus according to a preferred embodiment of the present invention shown in FIG. 1 is described as an information recording apparatus comprising a magnetic disk medium 200 employing a servo sector system structured by a patterned media which is, however, discretionary. The information recording apparatus shown in FIG. 1 comprises, in each of correction areas, a magnetic pattern for obtaining a signal for correcting a positioning of a head to a data area between servo sectors. The lower part of FIG. 1 shows an enlargement of the area A (30), showing the track direction of the disk medium 200 in the horizontal direction and the radial direction thereof in the vertical direction. And the information recording apparatus according to a preferred embodiment of the present invention embeds a magnetic pattern (which is described later) in a data area existing between a servo sector S1 (31) and a servo sector S2 (32) by a patterning, defines the respective areas embedded with the magnetic pattern as correction areas PA 11 (41), PA 12 (42) and PA 13 (43), and detects a phase shift amount based on a reproduction signal obtained from the correction areas. And the data area existing between the servo sector S1 (31) and servo sector S2 (32) are divided into four parts by the correction areas PA 11 (41), PA 12 (42) and PA 13 (43), and they are arrayed in even intervals as DA 11 (51), DA 12 (52), DA 13 (53) and DA 14 (54).

Referring to the lower part of FIG. 1, in the case of the magnetic head tracing from the left to right on the record track, a positional demodulation signal (which is described later) obtained by passing the servo sector S1 (31) is minutely corrected by a positional correction signal (which is described later) converted from a phase shift amount which is obtained by sequentially passing the correction areas PA 11 (41), PA 12 (42) and PA 13 (43), thereby becoming a positional signal (which is described later), followed by obtaining a positional modulation signal in the same manner at the servo sector S2 (32) which is subsequently traced, and further minutely corrected by a positional correction signal obtained by passing correction areas PA 21 (44), and so on. Such minute correction operations are performed for one circumference of a track, which is continued for carrying out an accurate positioning trace to a target track.

The configuration is such that the above described correction areas PA 11 (41), PA 12 (42), PA 13 (43), PA 21 (44), and so on, are structured by patterns connecting record bits of different tracks having a certain width, in which the correction areas PA 11 (41), PA 12 (42), PA 13 (43), PA 21 (44), and so on, are featured intermittently in plural places (i.e., three places according to the present embodiment) of a data area, in place of the servo sectors S1 (31) and S2 (32), and also utilizes servo pattern information which is placed in the servo sectors S1 (31) and S2 (32). Note that a magnetic disk medium employing a servo sector system arranges a servo sector by dividing an approximate circle track into even intervals and the aforementioned servo sector stores address information, such as a cylinder number and sector number for each sector, and burst information utilized for positioning within a track, and accordingly the preferred embodiment of the present invention also utilizes information stored in the servo sector. And a recording of magnetic information according to the preferred embodiment of the present invention is carried out by magnetizing a record bit in data areas DA 11 (51), DA 12 (52), DA 13 (53) and DA 14 (54) divided into four parts by the correction areas PA 11 (41), PA 12 (42) and PA 13 (43) existing between the above described servo sectors S1 (31) and S2 (32).

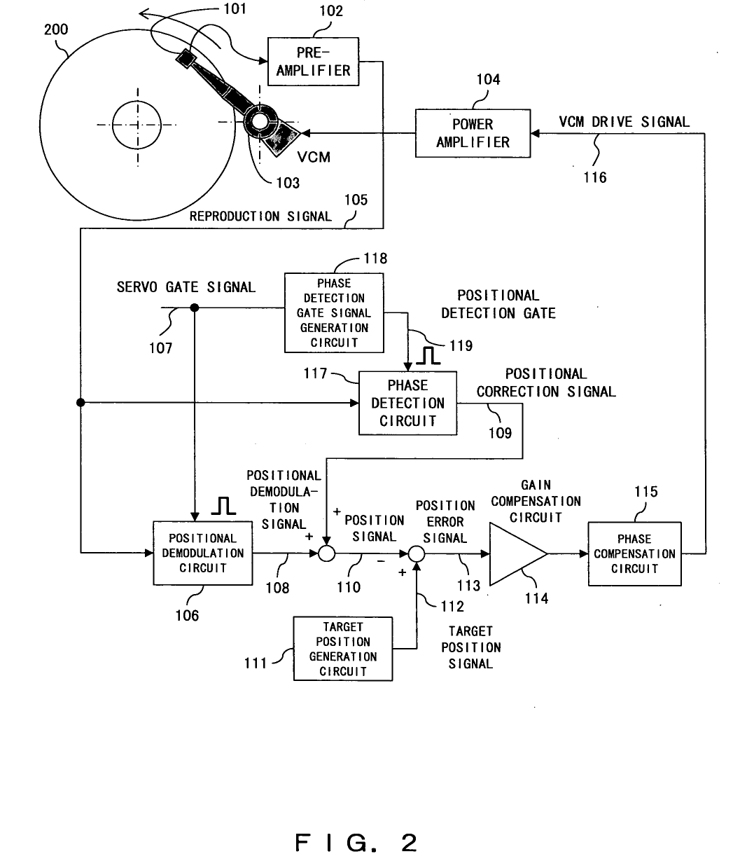

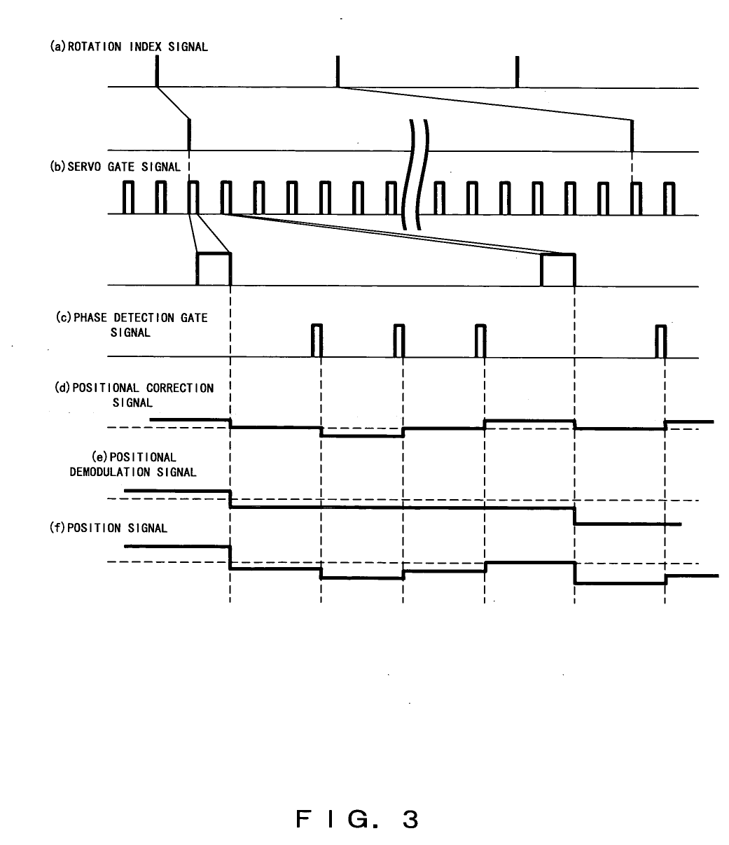

The next is a description on an operation of the information recording apparatus according to a preferred embodiment of the present invention by referring to FIGS. 2 and 3.

FIG. 2 is a diagram of a circuit block for performing a positioning control of a head of an information recording apparatus according to a preferred embodiment of the present invention. Referring to FIG. 2, a magnetic head 101 scans on a rotating magnetic disk medium 200 reproduces data from a sectored data area on the magnetic disk medium 200 and records data therein. The magnetic head 101 is moved by a moment around an axis being generated by driving a voice coil motor (VCM) 103 based on a current supplied from a power amplifier 104. This makes the magnetic head 101 move approximately in the radial direction of the magnetic disk medium 200. And the magnetic information recorded in the magnetic disk medium 200 is detected as current by the magnetic head 101 and output to be converted into a voltage by a pre-amplifier 102, followed by being input to a circuit at the later stage as a reproduction signal 105.

That is, the reproduction signal 105 is input to a positional demodulation circuit 106 which then outputs the reproduction signal 105 as a positional demodulation signal 108 only during the time when a servo gate signal 107 (which is described later) asserts the positional demodulation circuit 106. The servo gate signal 107 is a signal synchronous with a rotation of the magnetic disk medium 200 and furthermore for asserting the positional demodulation circuit 106 at a timing which servo information within a servo sector recorded in the magnetic disk medium 200 is reproduced. That is, the servo gate signal 107 does not constitute a signal asserted at a timing which the magnetic head 101 passes the correction areas PA 11 (41), PA 12 (42), PA 13 (43), PA 21 (44), and so on, according to the present invention.

The positional demodulation signal 108 output from the positional demodulation circuit 106 is added to a positional correction signal 109 (which is described later), becoming a position signal 110. The position signal 110 is applied by a subtraction process with an output of a target position generation circuit 111, that is, a target position signal 112, becoming a position error signal 113. The position error signal 113 is amplified by a gain compensation circuit 114, followed by a phase compensation circuit 115 applying phase compensation in order to stabilize a feedback loop, becoming a VCM drive signal 116. The power amplifier 104 drives the VCM 103 based on the VCM drive signal 116, and supplies the VCM 103 with a current for stably positioning the magnetic head 101 to a target position.

The reproduction signal 105 is also input to a phase detection circuit 117 which then imports the reproduction signal 105, and processes it, only at the time when a phase detection gate signal 119 (which is described later) is asserted, and converts a phase shift amount at the above described correction areas PA 11 (41), PA 12 (42), PA 13 (43), PA 21 (44), and so on, which are included in the reproduction signal 105 to an offset amount from the center of a track passed by the magnetic head 101, thereby outputting a positional correction signal 109. A phase detection gate signal generation circuit 118 generates a phase detection gate signal 119 at a timing counted by a timer (not shown herein) or counter (not shown herein) as the servo gate signal 107 as trigger. The phase detection gate signal 119 divides the servo gate signal 107 into several times of cycles synchronously therewith (refer to FIG. 3), and functions as signal for asserting the correction areas PA 11 (41), PA 12 (42), PA 13 (43), PA 21 (44), and so on, shown in FIG. 1 at the timing of the magnetic head 101 passing. The positional correction signal 109 is subjected to an addition process with the positional demodulation signal 108 that is an output of the positional demodulation circuit 106 as described above, thus becoming the position signal 110 for correcting the positional demodulation signal 108. The position signal 110 is subjected to a subtraction process with the target position signal 112 that is an output of the target position generation circuit 111, thus becoming the position error signal 113. The position error signal 113 is amplified by the gain compensation circuit 114, followed by being applied a phase compensation by the phase compensation circuit 115 for stabilizing a feedback loop, thus becoming the VCM drive signal 116. The power amplifier 104 drives the VCM 103 according to the VCM drive signal 116 and supplies the VCM 103 with a current for positioning the magnetic head 101 stably at a target position. The operation described above positions the magnetic head 101 stably at a target track of the magnetic disk medium 200.

FIG. 3 is a diagram showing a signal waveform in the circuit block shown in FIG. 2. A signal (a) shown in FIG. 3 is a rotation index signal obtained from a rotation drive system (not shown in FIG. 2) of the information recording apparatus and a signal which is output one time per rotation of the magnetic disk medium 200.

A signal (b), being the servo gate signal 107 shown in FIG. 2, is a signal asserted at the timing when information of a servo sector recorded in the magnetic disk medium 200 is reproduced in synchronous with the rotation index signal.

A signal (c), being the phase detection gate signal 119 shown in FIG. 2, is a signal divided equally by several times of cycles of the servo gate signal 107 and asserted at the timing which the magnetic head 101 passing the correction areas PA 11 (41), PA 12 (42), PA 13 (43), PA 21 (44), and so on, as shown in FIG. 1.

A signal (d) is the positional correction signal 109 which is output from the phase detection circuit 117 shown in FIG. 2 at the timing of the phase detection gate signal (c) described above being negated, and is a signal converted from a phase shift amount of the correction areas PA 11 (41), PA 12 (42), PA 13 (43), PA 21 (44), and so on, as shown in FIG. 1, into an offset amount from the center of a track passed by the magnetic head 101.

A signal (e) is the positional demodulation signal 108 output from the positional demodulation circuit 106 shown in FIG. 2 at the timing of the above described servo gate signal (b) being negated. A signal (f) is the position signal 110 shown in FIG. 2 and a signal adding the positional correction signal (d) to the above described positional demodulation signal (e).

As described above, the present embodiment is configured to employ a system of detecting a positional error synchronously with a data clock (which is supplied from a reproduction clock generation circuit (not shown herein) in synchronous with a record bit) and therefore the positioning information can be obtained with little consumption of a data area, and a format efficiency loss due to a servo pattern layout can be accordingly neglected inmost part. Also, the positioning information (i.e., the correction areas PA 11 through PA 13) can be finely inserted into a data area (i.e., between servo sectors), thereby making it possible to improve a sampling frequency of the positioning control and make easily a control system having a high bandwidth.

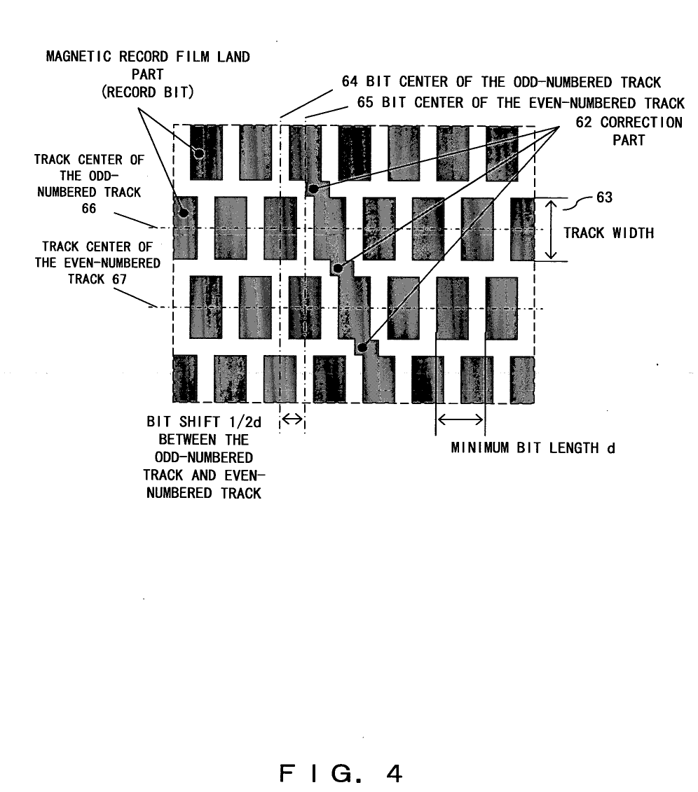

FIG. 4 is a diagram showing the first fundamental comprisal of a magnetic pattern in an information recording apparatus according to a preferred embodiment of the present invention. The magnetic pattern shown in FIG. 4 is one structured by comprising a connection part for connecting adjacent record bits by the same magnetic film as that of the record bit in one direction in record bits (i.e., magnetic record film land parts) of the patterned media noted in the patent document 2.

Referring to the patterned media shown in FIG. 4, an odd-numbered track and an even-numbered track are respectively equipped with the magnetic record film land parts (i.e., record bits) 61 having a predetermined track width 63. And the configuration is in a manner to have a connection part 62 for uni-directionally connecting a record bit 61 to a record bit 61 between the adjacent odd-numbered and even-numbered tracks. Incidentally, a bit center 64 of the odd-numbered track is shifted from a bit center 65 of the even-numbered track by a half of the minimum bit length d, that is, ½d as shown in FIG. 4. And the patterned media shown in FIG. 4 can be easily implemented by a production process of a common patterned media (refer to a Laid-Open Japanese Patent Application Publication No. 2001-110050 (FIG. 4) as appropriate).

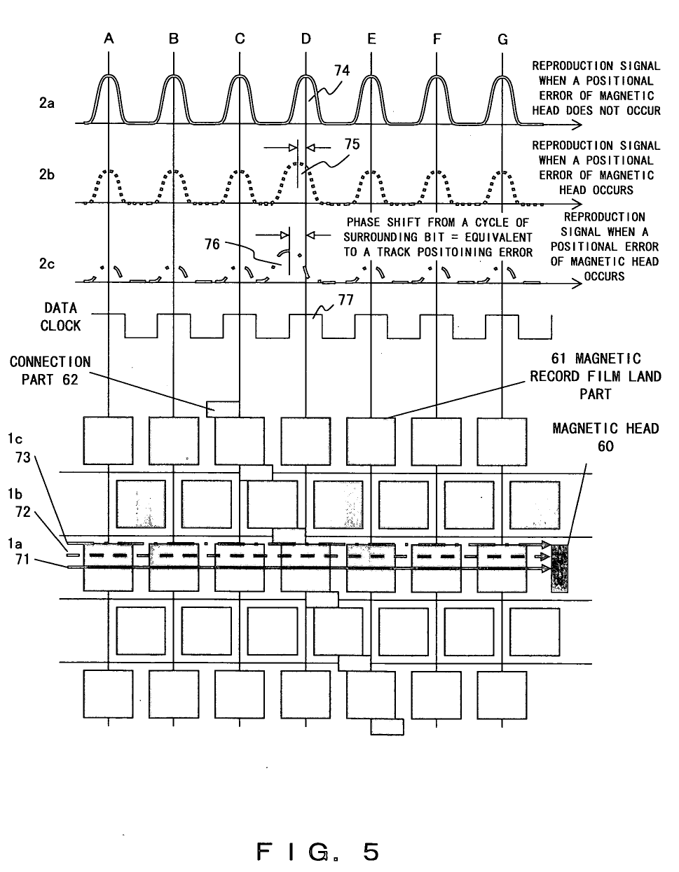

FIG. 5 is a diagram showing a reproduction signal waveform when tracing by offsetting a magnetic head from the center of a record track in the first fundamental comprisal of a magnetic pattern shown in FIG. 4, specifically showing a reproduction signal waveform when tracing by offsetting the magnetic head 60 from the centers of respective record tracks 66 and 67. Referring to FIG. 5, if the magnetic head 60 traces as a locus 1a (71) at the center of a record track (which is assumed to be a track center 66 shown in FIG. 4), obtained is a reproduction waveform 74 having an even amplitude and a certain phase on all of the record bits (i.e., magnetic record film land part) 61 shown by a waveform 2a.

In this event, if the magnetic head 60 is made to trace by offsetting a little toward the adjacent track as a locus 1b (72), a reproduction waveform 75 with a phase shift as indicated by the waveform 2b is obtained for the record bit part having the connection part 62 with the adjacent record bit.

If the magnetic head 60 is made to trace by offsetting greatly toward the adjacent track as a locus 1c (73), a reproduction waveform 76 with an increased phase shift amount as indicated by a waveform 2c is obtained for a record bit part having a connection part 62 with the adjacent record bit.

As such, the phase shift amount of a reproduction signal for a record bit having a connection part 62 between itself and adjacent record bit is in proportionate with an offset amount of a positioning of the magnetic head 60 relative to the track center, and therefore a positioning control of the head can be carried out by detecting the phase shift amount. Note that the above described phase shift amount is acquired as that related to a data clock 77 which is easily obtained from a reproduction clock generation circuit (not shown herein) for generating a reproduction clock in synchronous with a record bit.

Note that a record data string of a length required for generating the data clock 77 can be obtained by erasing data areas DA 11 (51), DA 12 (52), DA 13 (53) and DA 14 (54) in advance by a specified pattern (e.g., a repeat pattern of the same size to several times of the minimum bit length). After recording user data in the data area, the data clock 77 can be generated by using the user data.

Note that the example shown in FIG. 5 premises that all of the record bits are magnetized in a certain direction; a benefit of the present invention, however, can be obtained, provided at least that the record bit string of a record bit having a connection part between itself and an adjacent record bit, and the connection part, are magnetized in a certain direction.

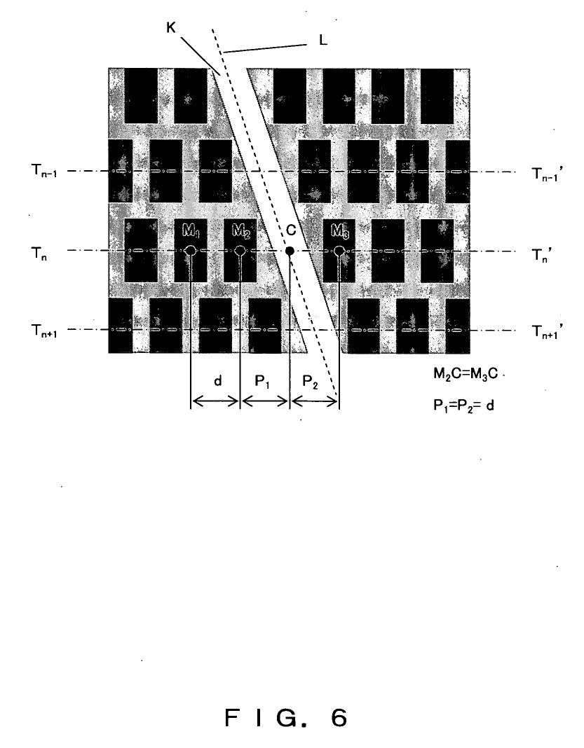

FIG. 6 is a diagram showing the first fundamental comprisal of a magnetic pattern in an information recording apparatus according to a preferred embodiment of the present invention. The magnetic pattern shown in FIG. 6 comprises a straight line pattern K traversing tracks in a certain direction and connecting them by the same magnetic film as the record bits in the patterned media noted in the patent document 2.

In the patterned media shown in FIG. 6, the distances P₁ and P₂ from the intersection C between the center line L of the straight line pattern K and the track center line Tₙ−Tₙ′ of the nth track to the adjacent bit center M₂ and M₃ has the relationship of P₁=P₂=d (where d is the distance between points M₁ and M₂, indicating the minimum record bit length). Note that the bit center of the nth track is shifted from the bit center of the (n+1)-th or (n−1)-th track by a ½d that is a half of the minimum bit length d, as shown in FIG. 6, which is the same as the first fundamental comprisal shown in FIG. 4. The patterned media as shown in FIG. 6 can also be easily implemented by a production process of a common patterned media (refer to a Laid-Open Japanese Patent Application Publication No. 2001-110050 (FIG. 4) as appropriate). Note also that the present embodiment has put forth a straight line pattern as the pattern K; it is, however, discretionary and may be a curved line pattern traversing the tracks in a certain direction and connecting between them by the same magnetic film as the record bits.

As described above, the second fundamental comprisal of the present invention is also contrived to generate a phase shift of a reproduction signal proportionately with an offset from the track center, and therefore a positioning control of a head can be carried out by detecting the phase shift amount.

Note that the comprisals shown in FIGS. 4 through 6 primarily put forth the fundamental comprisals of the magnetic pattern, whereas a configuration in actual practice is in a manner to obtain signals from magnetic patterns of plural diagonal streaks (e.g., refer to diagonal line parts of the correction areas shown in FIG. 1) when a magnetic head scans each track. The larger the number of streaks, the more accurately obtaining a positioning correction signal, while reducing an area to be used for a data area, and therefore it must be determined by a characteristic of each magnetic disk medium.

The present invention is capable of structuring a magnetic pattern without changing a process greatly, obtaining positioning information of the aforementioned magnetic pattern and improving positioning accuracy for a patterned media, thereby enabling an improvement of reliability in recording and reproducing data for a magnetic disk apparatus employing a patterned media structure.

What is claimed is:

1. A disk record medium having a track for recording data and comprising a servo sector in which a servo sector recording address information for positioning a head is intermittently placed in the track direction, comprising
at least one correction area usable for correcting a position of the head, in between the servo sectors in the track direction.

2. The disk record medium according to claim 1, wherein
said track is allocated to a land part, and said correction area is formed by connecting between the land parts by a magnetic record film.

3. The disk record medium according to claim 1, wherein
said correction area is formed by a curved line or straight line pattern.

4. The disk record medium according to claim 1, wherein
said servo sector at least records said address information and burst information, and said correction area records burst information.

5. A disk record medium forming a land along a circumferential direction and allocating a record track to the land, comprising
a zone in which the land continues intermittently in a radial direction.

6. An information recording apparatus reproducing information of a disk record medium enabling a reproduction of the information, or a recording of it therein, by a head moving in a direction of a track on the disk record medium, wherein
the disk record medium comprises a servo sector and at least one correction area between servo sectors in the track direction so as to divide and manage a record zone by the track and sector, to record address information for positioning the head and to divide a track, wherein
the correction area is utilized for correcting a position of the head.

7. The information recording apparatus according to claim 6, wherein
said disk record medium records information in a large number of land parts and connects between the land parts by a magnetic record film, thereby forming said correction area.

8. The information recording apparatus according to claim 7, wherein
a pattern of said magnetic record film is a straight line or a curved line pattern connecting between said land parts which are adjacent to each other.

9. The information recording apparatus according to claim 6, wherein
said servo sector at least records said address information and burst information, and said correction area records burst information.

10. The information recording apparatus according to claim 6, comprising
a phase detection unit for detecting said correction area from data of said disk record medium which is read by said head.

11. The information recording apparatus according to claim 10, comprising
a phase detection gate generation unit for generating a phase detection gate signal for driving said phase detection unit after detecting said servo sector.

12. An information recording apparatus having a servo sector, comprising:
a servo pattern recorded within the servo sector;
a magnetic pattern embedded in a predetermined position of a data zone between the servo sectors by a patterning in order to detect a phase shift amount in relation to a data clock;
a unit for obtaining a positional demodulation signal, which is used for a positioning control, from the servo pattern;
a unit for detecting a phase shift amount from the magnetic pattern;
a unit for obtaining a positioning correction signal from the detected phase shift amount; and
a unit for stabilizing a magnetic head at a predetermined position by correcting the positional demodulation signal by the positioning correction signal.

13. The information recording apparatus according to claim 12, wherein
said phase shift amount detection unit obtains a reproduction signal of said magnetic pattern asserted by an output of a timing signal generation circuit which is triggered by a signal generated at a timing of reproducing said servo pattern which is synchronous with a rotation speed of a medium.

14. The information recording apparatus according to claim 12, wherein
said positioning correction signal obtainment unit converts said phase shift amount into an amount of offset from a center of a track on which a magnetic head has passed.

15. A head positioning control method for use in an information recording apparatus having a servo sector, comprising the processes of:
obtaining a positional demodulation signal, which is used for a positioning control, from a servo pattern which recorded within the servo sector;
detecting a phase shift amount from the magnetic pattern which is patterned in order to detect a phase shift amount in relation to a data clock at a predetermined position of a data zone between the servo sectors;
obtaining a positioning correction signal from the detected phase shift amount; and
stabilizing a magnetic head at a predetermined position by correcting the positional demodulation signal by the positioning correction signal.
